(19) United States
(12) Patent Application Publication
(10) Pub. No.: US 2025/0377481 A1
(43) Pub. Date: Dec. 11, 2025

(54) SYSTEMS AND METHODS FOR SUBSURFACE MODELING

(71) Applicant: Schlumberger Technology Corporation, Sugar Land, TX (US)

(72) Inventors: Marie Etchebes, Clamart (FR); Julien Renaudeau, Lysaker (NO); Marie Emeline Cecile LeFranc, Lysaker (NO); Bruno Tamain, Montpellier (FR); Peter Schlicht, Bucharest (RO); Jean-Michel Denichou, Tananger (NO)

(21) Appl. No.: 19/232,492

(22) Filed: Jun. 9, 2025

Related U.S. Application Data
(60) Provisional application No. 63/658,071, filed on Jun. 10, 2024.

(51) Int. Cl. G01V 20/00; E21B 47/04

(52) U.S. Cl. CPC G01V 20/00; E21B 47/04; E21B 2200/20

(57) ABSTRACT

A method of modeling a subsurface geology includes receiving measurement data from a downhole operation of a wellbore and identifying a subsurface feature from the measurement data. The method also includes creating a geobody for representing the subsurface feature and generating a downhole scenario including the geobody and a wellbore representation of the wellbore. The method further includes presenting the downhole scenario via a graphical user interface of a client device for conceptualizing the subsurface feature.

### CROSS REFERENCE TO RELATED APPLICATIONS

This application claims priority to and the benefit of U.S. Provisional Patent Application No. 63/658,071, filed on Jun. 10, 2024, which are hereby incorporated by reference in their entireties.

### BACKGROUND OF THE DISCLOSURE

Wellbores may be drilled into a surface location or seabed for a variety of exploratory or extraction purposes. For example, a wellbore may be drilled to access fluids, such as liquid and gaseous hydrocarbons, stored in subterranean formations and to extract the fluids from the formations. Wellbores used to produce or extract fluids may be formed in earthen formations using earth-boring tools such as drill bits for drilling wellbores and reamers for enlarging the diameters of wellbores.

A downhole system may be operated with respect to various subsurface features, for example, in order to access, avoid, or otherwise operate in relation to faults, slumps, lobes, channels, etc. It may be advantageous to model or simulate these features in order to conceptualize them and make informed decisions with respect to wellbore operations. In many cases, however, detailed and accurate subsurface models may be time consuming, complex, and overly robust, and decisions may need to be taken before such models may be provided. Thus, it may be advantageous to represent various subsurface features in a simple and timely manner with geobodies for conceptualizing various downhole scenarios in relation to a wellbore.

### SUMMARY

In some embodiments, a method of modeling a subsurface geology includes receiving measurement data from a downhole operation of a wellbore and identifying a subsurface feature from the measurement data. The method also includes creating a geobody for representing the subsurface feature and generating a downhole scenario including the geobody and a wellbore representation of the wellbore. The method further includes presenting the downhole scenario via a graphical user interface of a client device for conceptualizing the subsurface feature. In some embodiments, the method is performed by a computer system. In some embodiments, the method is performed as instructions stored on a computer-readable storage medium.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is an example of a downhole system, according to at least one embodiment of the present disclosure;

FIG. 2-1 illustrates an example environment in which a downhole scenario system is implemented, according to at least one embodiment of the present disclosure;

FIG. 2-2 illustrates an example implementation of a downhole scenario system as described herein, according to at least one embodiment of the present disclosure;

FIG. 3 is an example of a downhole scenario generated by the downhole scenario system as described herein, according to at least one embodiment of the present disclosure;

FIG. 4 is an example of a downhole scenario generated by the downhole scenario system as described herein, according to at least one embodiment of the present disclosure;

FIG. 5 is an example of a downhole scenario generated by the downhole scenario system as described herein, according to at least one embodiment of the present disclosure;

FIG. 6 is an example of a downhole scenario generated by the downhole scenario system as described herein, according to at least one embodiment of the present disclosure;

FIG. 7 illustrates a flow diagram for a method or a series of acts for modeling a subsurface geology as described herein, according to at least one embodiment of the present disclosure; and

FIG. 8 illustrates certain components that may be included within a computing system.

### DETAILED DESCRIPTION

This disclosure generally relates to a platform for simple, efficient, and timely generation of geobodies for conceptualizing subsurface features. For instance, the platform can facilitate identifying, from measurement data for a wellbore, a subsurface feature, either through user interpretation or automatically with no user input. Based on identifying the subsurface feature, the platform creates a geobody representative of the subsurface feature. The geobody may be (e.g., a generic geobody) based on a feature type of the subsurface feature, may be an analog to the subsurface feature, or may be a customized geobody for accurately representing the actual characteristics of the subsurface feature. The platform facilitates the modification and manipulation of the geobody for conceptualizing various different forms, positions, orientations, etc. of the subsurface feature, including creating several different geobodies for representing different potential forms of the subsurface feature.

Based on the geobody, the platform generates a downhole scenario for representing the subsurface feature with respect to the wellbore. For example, the platform constrains the geobody to a specific measurement depth where the subsurface feature was identified, and presents the geobody with respect to a virtual representation of the wellbore. The downhole scenario may be a 2- or 3-dimensional visual model or other representation of the geobody constrained to the wellbore representation, and in this way the downhole scenario facilitates the conceptualization of the subsurface feature with respect to a target or active wellbore of interest.

The platform facilitates validating the geobody(ies) and the downhole scenario(s). For instance, the validity of a downhole scenario may be verified against one or more additional downhole measurements to ensure that the geobody and the downhole scenario accurately represents that subsurface feature, based confirming that observable patterns, measurement values, or other data features are consistent with the form, shape, placement, etc. of the geobody. In some cases, multiple scenarios may be provided as potential or candidate scenarios for representing a subsurface feature, and based on verification, one scenario may be selected as being most accurate or the best representation of the subsurface feature. In another example, a downhole scenario may serve as the basis for a downhole or subsurface simulation, and the downhole scenario may be validated based on the simulation producing simulated measurement data that is substantially similar to the actual, measured measurement data. In this way, the platform may facilitate the conceptualization and visualization of subsurface features for informing drilling decisions based on creating, manipulating, and validating downhole scenarios that represent subsurface features encountered by a wellbore.

As will be discussed in further detail below, the present disclosure includes a number of practical applications having features described herein that provide benefits and/or solve problems associated with representing and conceptualizing subsurface features. Some example benefits are discussed herein in connection with various features and functionalities provided by a downhole scenario system implemented on one or more computing devices. It will be appreciated that benefits explicitly discussed in connection with one or more embodiments described herein are provided by way of example and are not intended to be an exhaustive list of all possible benefits of the downhole scenario system.

For example, the downhole scenario system described herein provides a simple, efficient, and timely visualization of subsurface features in order that the form, shape, position, orientation, extent, etc. of the subsurface features may be quickly and easily digested and conceptualized. In this way, informed decisions may be made for downhole systems in a timely manner, facilitating the day-to-day decision making and changing circumstances encountered by downhole operations. This is in contrast to conventional subsurface modelling techniques, which may implement sophisticated, highly accurate, and robust modelling of a subsurface geology that, while may be highly representative of a subsurface feature, may cost significant time and computing resources to generate. For instance, more robust, accurate models may take days, weeks, or even months to complete, significantly reducing their usefulness for informing time-dependent decision making. Additionally, these conventional models may model many aspects of the subsurface geology and may provide information beyond what is more immediately needed for making a sensitive decision for a downhole system. Along these lines, more robust models may typically require many different types of measurements and/or data inputs (e.g., for the same and/or different wellbores) to accurately model the geology, increasing the operational burden and computational resources of implemented such methods. Further, because of the high cost of time and resources, it may be impractical or unrealistic to create several subsurface models for representing a subsurface feature in a variety of different ways, as well as for updating and modifying these models to accommodate changing downhole circumstances. The downhole scenario system described herein overcomes all of these limitations by providing a simpler, more efficient, and more timely approach to representing subsurface features.

For instance, the downhole scenario system can identify a subsurface feature and generate a corresponding geobody for representing this subsurface feature based on a single data channel or measurement data type (e.g., from basic to high resolution measurements along the wellbore). For instance, the downhole scenario system 120 may provide geobody representations of detected subsurface features as generic or rough geobodies (e.g., generic to a feature type), as analog geobodies that are somewhat tailored to the specific characteristics of the subsurface feature, or as fully customized geobodies that accurately represent the form, shape, etc. of the subsurface feature. Thus, the geobody representation may provide a useful visualization of a subsurface feature that may lack some detail and/or specifics, but may nevertheless prove useful for informing time-sensitive decisions. For instance, some information or data about a subsurface feature may be unknown, for example, due to limitations of a resolution of a specific type of measurement data (e.g., seismic) or simply due to a lack of relevant measurements for a subsurface region, and as such, it may not be possible or practical to generate a more complex, accurate geobody for representing the subsurface feature based on the number of unknowns.

For example, the downhole scenario system creates a downhole scenario by constraining the geobody to a wellbore representation in order that a simplified representation of the subsurface feature with respect to the wellbore may be visualized to conceptualize the feature and its implications for a downhole operation. Because of this simple approach, geobodies and downhole scenarios may be easily generated and manipulated in a timely manner and with little computing resources. For instance, downhole scenarios may be generated in real time or near real time. Thus, a subsurface feature such as a fault, slump, channel, lobe, etc. may be visualized and conceptualized by drilling personnel as it is detected or encountered in order to facilitate making day-to-day decisions, for example, rather than waiting weeks for a robust model to be created, which very well may include information above that which is needed for the decision at hand.

Further the simplicity and timeliness of the downhole scenario system can be facilitated by generating downhole scenarios and validating the scenarios (e.g., after creating). For instance, a scenario may be validated based on additional measurement data as is it received or from additional wellbores, as well as from simulations based on the downhole scenario. Thus, by providing a possibly-not-wholly-accurate scenario, but doing so quickly and simply, the downhole scenario may be validated based on ensuring that the scenario is consistent with, or accurately explains or reconciles, observed measurements from one or more sources. In a particular example, several potential geobodies and several potential downhole scenarios for representing a subsurface feature may be provided. For instance, each potential geobody may differ in one or more respects for representing possible or plausible downhole scenarios for the subsurface feature in the face of a more limited time frame and more limited (e.g., a single channel of) information. This multi-scenario approach proves useful, however, in that these scenarios may be validated to select a best-fit representation of the subsurface feature such that relevant information may be provided to aide in conceptualization of subsurface features and timely decision making.

Still further, the downhole scenario system facilitates modification and manipulation of geobodies and downhole scenarios to advantageously provide adaptability and/or updating on the fly. For instance, a size, shape, angle, etc., of a geobody may be modified, for example, to better conform to a predicted or expected form of the subsurface geology, to more accurately reflect one or more known or expected properties or characteristics of a subsurface feature, and/or to explore different possible scenarios for explaining or reconciling observable measurements related to the subsurface feature. The lengthy time frame for creating more in-depth, robust models makes on-the-fly modifications and numerous manipulations unrealistic and impractical. Further, the methodology of providing a highly accurate, detailed subsurface model is at odds with that of the downhole scenario system, that is, to provide a quick, sometimes rough approximation of a subsurface feature for easy and fast conceptualization via a geobody, while allowing modification of the geobody as needed to inform time-dependent drilling decisions.

Thus, the downhole scenario system provides the practical application of facilitating ease of conceptualization of subsurface features through a simple visual aide and does so through the technical benefit of increased simplicity, timeliness, and adaptability, while reducing computational expense over conventional approaches.

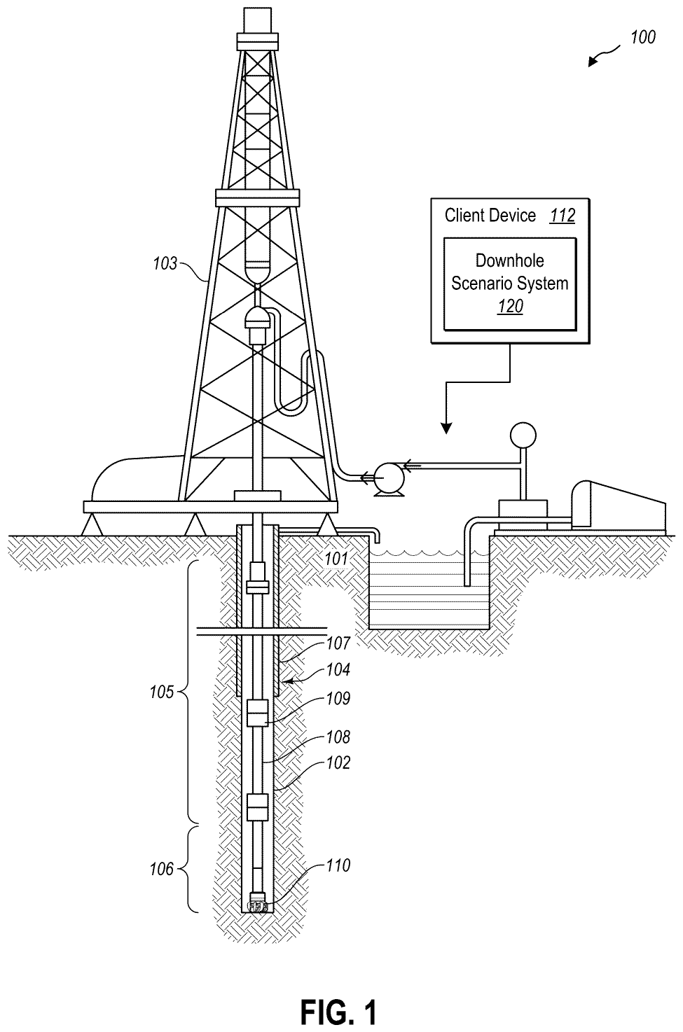

Additional details will now be provided regarding systems described herein in relation to illustrative figures portraying example implementations. For example, FIG. 1 shows one example of a downhole system 100 for drilling an earth formation 101 to form a wellbore 102. The downhole system 100 includes a drill rig 103 used to turn a drilling tool assembly 104 which extends downward into the wellbore 102. The drilling tool assembly 104 may include a drill string 105, a bottomhole assembly (“BHA”) 106, and a bit 110, attached to the downhole end of the drill string 105.

The drill string 105 may include several joints of drill pipe 108 connected end-to-end through tool joints 109. The drill string 105 transmits drilling fluid through a central bore and transmits rotational power from the drill rig 103 to the BHA 106. In some embodiments, the drill string 105 further includes additional downhole drilling tools and/or components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the wellbore 102 as it is being drilled.

The BHA 106 may include the bit 110, other downhole drilling tools, or other components. An example BHA 106 may include additional or other downhole drilling tools or components (e.g., coupled between the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing.

In general, the downhole system 100 may include other downhole drilling tools, components, and accessories such as special valves (e.g., kelly cocks, blowout preventers, and safety valves). Additional components included in the downhole system 100 may be considered a part of the drilling tool assembly 104, the drill string 105, or a part of the BHA 106, depending on their locations in the downhole system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed-cutter or drag bits. In other embodiments, the bit 110 may be a mill used for removing metal, composite, elastomer, other materials downhole, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to the surface 111 or may be allowed to fall downhole. The bit 110 may include one or more cutting elements for degrading the earth formation 101.

The BHA 106 may further include a rotary steerable system (RSS). The RSS may include directional drilling tools that change a direction of the bit 110, and thereby the trajectory of the wellbore. At least a portion of the RSS may maintain a geostationary position relative to an absolute reference frame, such as one or more of gravity, magnetic north, or true north. Using measurements obtained with the geostationary position, the RSS may locate the bit 110, change the course of the bit 110, and direct the directional drilling tools on a projected trajectory. The RSS may steer the bit 110 in accordance with or based on a trajectory for the bit 110. For example, a trajectory may be determined for directing the bit 110 toward one or more subterranean targets such as an oil or gas reservoir.

The downhole system 100 may include or may be associated with a client device 112 with a downhole scenario system 120 implemented thereon (e.g., or with a client application implemented thereon for accessing the downhole scenario system 120 as described herein). The downhole scenario system 120 may facilitate generating downhole scenarios for conceptualizing various subterranean features as geobodies constrained to a representation of a wellbore.

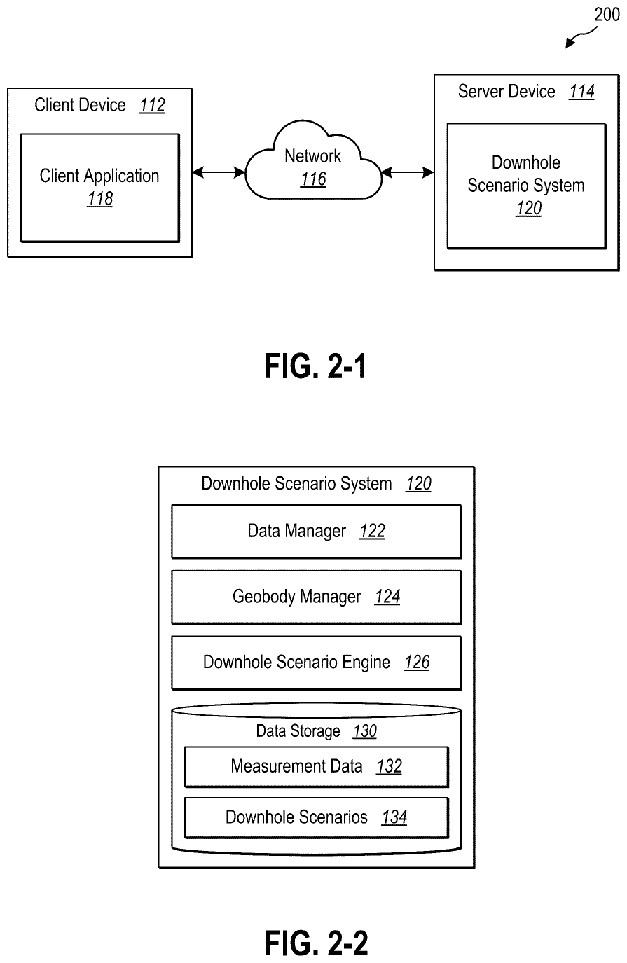

FIG. 2-1 illustrates an example environment 200 in which a downhole scenario system 120 is implemented in accordance with one or more embodiments describe herein. As shown in FIG. 2-1, the environment 200 includes a server device 114. The server device 114 may include one or more computing devices (e.g., including processing units, data storage, etc.) organized in an architecture with various network interfaces for connecting to and providing data management and distribution across one or more client systems. As shown in FIG. 2-1, the server device 114 may be connected to and may communicate with (either directly or indirectly) a client device 112 through a network 116. The network 116 may include one or multiple networks and may use one or more communication platforms and/or technologies suitable for transmitting data. The network 116 may refer to any data link that enables transport of electronic data between devices of the environment 200. The network 116 may refer to a hardwired network, a wireless network, or a combination of a hardwired network and a wireless network. In one or more embodiments, the network 116 includes the internet. The network 116 may be configured to facilitate communication between the various computing devices via well-site information transfer standard markup language (WITSML) or similar protocol, or any other protocol or form of communication.

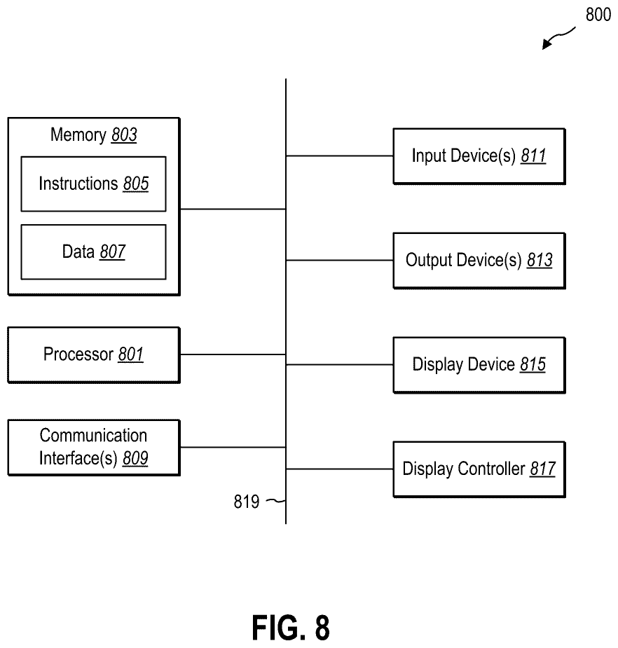

The client device 112 may be representative of one or multiple client devices, and may refer to various types of computing devices. For example, the client device 112 may include a mobile device such as a mobile telephone, a smartphone, a personal digital assistant (PDA), a tablet, a laptop, or any other portable device. Additionally, or alternatively, the client device 112 may include one or more non-mobile devices such as a desktop computer, server device, surface or downhole processor or computer (e.g., associated with a sensor, system, or function of the downhole system), or other non-portable device. In one or more implementations, the client device 112 includes graphical user interfaces (GUI) thereon (e.g., a screen of a mobile device). In addition, or as an alternative, one or more of the client device 112 may be communicatively coupled (e.g., wired or wirelessly) to a display device having a graphical user interface thereon for providing a display of system content. The server device 114 may similarly refer to various types of computing devices. Each of the devices of the environment 200 may include features and/or functionalities described below in connection with FIG. 8.

As shown in FIG. 2-1, the environment 200 may include a downhole scenario system 120 implemented on the server device 114. While shown on the server device 114, the downhole scenario system 120 may be implemented wholly or in part on the client device 112, across the server device 114 and the client device 112, or on or across one or more additional devices, such that different portions or components of the downhole scenario system 120 are implemented on different computing devices in the environment 200. The client device 112 may include a client application 118. The client application 118 may include an application or interface for interacting with and/or receiving the features of the downhole scenario system 120 as described herein. In some embodiments, one or more of the functionalities or features of the downhole scenario system 120 may be carried out or performed on or by the client application 118. In this way, the environment 200 may be a cloud computing environment, and the downhole scenario system 120 may be implemented across one or more devices of the cloud computing environment in order to leverage the processing capabilities, memory capabilities, connectivity, speed, etc., that such cloud computing environments offer in order to facilitate the features and functionalities described herein.

FIG. 2-2 illustrates an example implementation of the downhole scenario system 120 as described herein, according to at least one embodiment of the present disclosure. The downhole scenario system 120 may include a data manager 122, a geobody manager 124, and a downhole scenario engine 126. The downhole scenario system 120 may also include a data storage 130 having measurement data 132 and downhole scenarios 134 stored thereon. While one or more embodiments described herein describe features and functionalities performed by specific components 122-126 of the downhole scenario system 120, it will be appreciated that specific features described in connection with one component of the downhole scenario system 120 may, in some examples, be performed by one or more of the other components of the downhole scenario system 120.

By way of example, one or more of the data receiving, gathering, or storing features of the data manager 122 may be delegated to other components of the downhole scenario system 120. As another example, while geobodies may be selected, created, and/or modified by the geobody manager 124, in some instances, some or all of these features may be performed by the downhole scenario engine 126 (or other component of the downhole scenario system 120). Indeed, it will be appreciated that some or all of the specific components may be combined into other components and specific functions may be performed by one or across multiple components 122-126 of the downhole scenario system 120.

Additionally, while FIG. 1, for example, depicts the downhole scenario system 120 implemented on a client device 112 of the downhole system, it should be understood that some or all of the features and functionalities of the downhole scenario system 120 may be implemented on or across multiple client devices 112 and/or server devices 114. For example, data may be input and/or received by the data manager 122 on a (e.g., local) client device, and one or more downhole scenarios may be generated on one or more of a remote, server, or cloud device. Indeed, it will be appreciated that some or all of the specific components 122-126 may be implemented on or across multiple client devices 112 and/or server devices 114, including individual functions of a specific component being performed across multiple devices.

As mentioned above, the downhole scenario system 120 includes a data manager 122. The data manager 122 may receive a variety of types of data associated with the downhole system and may store the data to the data storage 130. The data manager 122 may receive the data from a variety of sources, such as from sensors, surveying tools, downhole tools, other (e.g., client) devices, libraries, databases, user input, etc.

In some embodiments, the data manager 122 receives measurement data 132, for example, of one or more downhole and/or surface measurements from a wellbore. The measurement data 132 may be raw measurement data and/or raw signals received from one or more sensors or other equipment. For instance, the measurement data 132 may be received from LWD tools, MWD tools, wireline tools, borehole imaging tools, survey tools, or any other measurement tool, sensor, or device for measuring relevant wellbore measurement data. For example, the measurement data 132 may include measurements related to one or more of pressure, temperature, rotational speed (RPM), weight on bit (WOB), torque, rate of penetration (ROP), resistivity, seismic, gamma ray, or any other type of measurement. The measurement data 132 may be data received and/or collected from or with respect to a target wellbore of interest and/or may be data associated with one or more additional wellbores such as offset wellbores or sidetrack wellbores.

In some embodiments, the data manager 122 receives user input. The data manager 122 may receive the user input, for example, via any of the client devices 112 and/or server devices 114. Any of the data described herein may be input or augmented via the user input. For example, in some instances, some or all of the downhole tool data 132 is received by the data manager 122 as user input. The user input may be received in association with one or more functions or features of the downhole scenario system 120, such as part of identifying subsurface features, selecting and/or modifying geobodies, or any other feature described herein.

In some embodiments, the data manager 122 may facilitate identifying one or more subsurface features from the measurement data 132. For example, the data manager 122 may facilitate a user interpreting and selecting from the measurement data one or more subsurface features. In another example, the data manager 122 may process and/or analyze the measurement data 132 and may identify from the measurement signals one or more data features or artifacts corresponding to an identifiable subsurface feature. For instance, the data manager 122 may implement one or more machine learning models that are trained to process input measurement data and classify various subsurface features from the underlying data signals.

In some embodiments, the data manager 122 identifies one or more subsurface features and/or subsurface feature types based on a data type of the measurement data. For example, based on a specific type of measurement data, the data manager 122 may identify a particular type of subsurface feature that is (e.g., typically) identifiable within the measurement data. The data manager 122 may indicate the feature type, for example, for facilitating selecting or creating a geobody as described herein. In some embodiments, the data manager 122 may identify the subsurface feature(s) based on only a limited set of measurement data 132, such as based on one type or signal source of the measurement data. For example, the data manager 122 may analyze borehole image data such as resistivity data and may identify one or more slumps from the data. By utilizing one, or a limited set, of types of measurement data, the downhole scenario system 120 can provide a quick and simple contextualization of subsurface features, for example, in contrast to more robust, detailed downhole modeling and/or analyses as described herein.

The data manager 122 may identify any number of subsurface features from the measurement data 132 and may identify any number of different types of subsurface features of interest. For example, the data manager 122 may identify flow barriers such as baffles. In another example, the data manager 122 may identify sedimentary depositional environments (e.g., clastic or carbonate) such as channels, point bars, crevasse splays, bars, abandoned channels, distributary channels, lobes, levees, slumps, injectites, mounds, bars, bows, pinnacles, reefs, fans, clinoforms, lagoons, forereefs, and backreefs. In another example, the data manager 122 may identify intrusive bodies such as dykes and veins. In another example, the data manager 122 may identify structural features such as faults. The data manager 122 may identify any other feature or type of feature relevant to the forming and operation of a wellbore and/or to the understanding of a subsurface geology. The data manager 122 may indicate a measurement depth (MD) corresponding with the location of the identified subsurface feature. In this way, the downhole scenario system 120 may facilitate quickly identifying subsurface features in order that they may be represented and conceptualized in order to facilitate making wellbore decisions.

As mentioned above, the downhole scenario system 120 includes a geobody manager 124. The geobody manager 124 may facilitate creating geobodies for representing subsurface features. For instance, a geobody may be a 2 or 3-dimensional conceptual surface, shape, volume, or other object that may resemble, approximate the form of, or otherwise represent a subsurface feature. For instance, a geobody may be a prism, polygon, circle, oval, pipe, half pipe, ellipse, lobe, fan lobe, crescent, straight channel, meandering channel, anastomosed channel, box, ellipse, half ellipse, ellipsoid, wedge, oxbow lake, dune, mound, cone, bow, clinoform, sheet, or any other uniform or non-uniform shape, surface, or volume. In this way, a geobody may be a visual or conceptual representation of a subsurface feature. As used herein, creating a geobody may include selecting a predefined geobody, generating a new and/or custom geobody, and/or modifying a geobody.

In some embodiments, the geobody manager 124 may create a geobody based on input from a user. For example, based on an identified subsurface feature (e.g., by a user or automatically by the downhole scenario system 120 as described herein) the geobody manager 124 may facilitate a user selecting a geobody for representing the identified subsurface feature. For example, the geobody manager 124 may present a library or catalogue of predefined geobodies, and the user may select a geobody from the library for representing the subsurface feature. For instance, the catalogue may include various types of geobodies and/or may include several geobodies of each type. For example, an identified subsurface feature may be a channel, and the geobody manager 124 may facilitate a user selecting a channel geobody for representing the subsurface feature. In some embodiments, the geobody manager 124 may identify a subset of the library and may facilitate a user selecting a geobody from that subset. For example, the data manager 122 may identify a subsurface feature of a given feature type, and the geobody manager 124 may propose a set of one or more geobodies corresponding to that feature type from the library for the user to select from.

In some embodiments, the geobody manager 124 may create a geobody automatically and/or without user input. For example, the geobody manager 124 may select a (e.g., generic) geobody of a feature type corresponding to an identified subsurface feature (e.g., as determined by the data manager 122).

In some embodiments, the geobody manager 124 may select a geobody based on identifying an analog geobody from a library of predefined geobodies. For example, based on the measurement data signal from which a subsurface feature was identified, the geobody manager 124 may identify an analog geobody having an underlying measurement data signal that is similar in one or more ways to the measurement data signal. For instance, the geobody manager 124 may implement a geobody machine learning model that is trained to analyze the measurement data 132 (e.g., and more specifically a portion of the measurement data 132 corresponding to an identified subsurface feature) and select an analog geobody that is most similar to and/or was generated from a data signal that is most similar to the measurement data 132. The analog geobody may thus have a shape, size, or form that is more similar to the identified subsurface feature than, for example, a generic geobody or a geobody that is only similar in feature type to the identified subsurface feature.

In some embodiments, the geobody manager 124 may create a geobody by generating a geobody that is new (e.g., not predefined) and/or custom to the identified subsurface feature. For example, the geobody manager 124 may analyze the measurement data signal and may generate a geobody having a shape, size, form, dimension, etc. that resembles and/or accurately represents the actual subsurface feature. For example, the geobody manager 124 may generate a 2 or 3-dimensional point cloud based on measurements from the measurement data 132 for accurately representing a surface or volume of the subsurface feature. The geobody manager 124 may implement machine learning models for creating a custom geobody. For example, a geobody machine learning model may be trained to process the measurement data, including the identifiable data feature and/or artifacts in the measurement data corresponding to an identifiable subsurface feature, and may generate a geobody that reconciles these data features as a corresponding subsurface feature. For instance, the measurement data may be resistivity or gamma ray imaging data (e.g., from a continuous or discrete log) and may include one or more data instances having measurement values or other characteristics that indicate a particular subsurface feature, such as a lobe. A geobody machine learning model may be trained to generate a geobody of a particular size, shape, and form, which may accurately reconcile or explain the characteristics of the measurement data as an identifiable subsurface feature. A geobody machine learning model may be trained in this way to process any type and any number of different types of measurement data and/or inputs for generating a new geobody, such as age, net gross for each depositional environment, density, dip, facies classification, gamma ray, grain size, time index, compressional wave velocity, shear wave velocity, porosity, strike, volume of clay, volume of shale, sonic data, petrophysical properties, and discrete facies logs. In this way, the geobody manager 124 may create a unique or tailored geobody for more accurately representing a subsurface feature.

As mentioned above, a geobody may be a 2 or 3-dimensional object that represents the form, shape, etc. of a subsurface feature. In some embodiments, the geobody manager 124 may apply the underlying measurement data 132 to the geobody. For example, the geobody manager may interpret the magnitude and/or values of the measurement data signal as one or more colors, textures, patterns, etc. and may apply these interpretations to the (e.g., shape of the) geobody. In this way, the geobody may present a visual representation of the form of the subsurface feature, and may additionally include relevant information from the associated measurement data in a visual and easily conceptualized form.

In some embodiments, the geobody manager 124 may facilitate manipulating and/or modifying a (e.g., predefined or custom) geobody. For example, after a geobody is created (e.g., selected or generated), the geobody manager 124 may modify one or more of a dip, tilt, azimuth, size, shape, transversal extension, longitudinal extension, transversal position, dimension, or other characteristic of the geobody. For example, the geobody manager 124 may facilitate a user modifying the geobody. In another example, the geobody manager 124 may implement one or more changes to the geobody automatically and without user input. For instance, the geobody manager 124 may select a predefined and/or analog geobody from a library, and, based on the measurement data, may perform one or more modifications to the geobody in order that the geobody provides a better fit to the measurement data.

In some embodiments, the geobody manager 124 may create several geobodies for representing (e.g., a single) subsurface feature. For example, based on an identified subsurface feature from the measurement data, the geobody manager 124 may generate several geobodies for representing the subsurface feature, and each geobody may be different in one or more respects, such as having different sizes, shapes, feature types, transversal or longitudinal extension, lateral position, tilt, etc. Providing several geobodies for the same subsurface feature may facilitate exploring and conceptualizing several different downhole scenarios, as described herein, for representing the subsurface feature and/or for explaining an identifiable data feature in the measurement data. For example, as described herein, one or more of the geobodies may not be accurate to and/or may not be an accurate representation of the (e.g., actual) subsurface feature. However, generating and providing several possible and/or plausible geobodies for representing a subsurface feature (e.g., and later selecting/verifying one of the geobodies) may facilitate the simplistic and efficient approach of the downhole scenario system 120 for conceptualizing the subsurface feature.

For instance, in some embodiments, the downhole scenario system 120 may receive the measurement data 132, may identify subsurface features, and may create geobodies for representing those subsurface features in real time or near real time. For instance, the downhole scenario system 120 may operate in this manner in a matter of minutes or hours for providing geobodies and facilitating the conceptualization of subsurface features in order that informed decisions may be made with respect to a downhole operation quickly and efficiently. This may be in contrast to, for example, other conventional approaches which may provide detailed, in-depth subsurface models that may have highly accurate and precise representations of subsurface features, but which may delay significantly in providing a useful decision aide. For example, some more sophisticated downhole models may take days, weeks, or even months to generate and/or may be reliant on many sources of data and measurements to create. Thus, such models may not be relied upon for informing day-to-day decisions of a downhole system and adapting on the fly to current and/or changing circumstances. The downhole scenario system 120, however, may create and provide geobodies based on limited (e.g., 1) source of measurement data as it is received and as subsurface features are encountered, and may provide a useful decision aid for visualizing and conceptualizing the subsurface feature in order that timely decisions may be made to facilitate continuing a downhole operation.

As mentioned above, the downhole scenario system 120 includes a downhole scenario engine 126 for generating downhole scenarios 134 including one or more geobodies. As used herein, a downhole scenario is an association of a geobody with target wellbore or wellbore of interest. For example, a downhole scenario may be a visual representation, such as a model, that presents the geobody with respect to a wellbore representation of the wellbore. A downhole scenario may be a 2-dimensional or 3-dimensional visual representation or model, and the downhole scenario engine 126 may present the downhole scenario via a graphical user interface, for example, to a user of a client device.

As just mentioned, the downhole scenario engine 126 generates a wellbore representation of the target wellbore. The wellbore representation may be a shape, surface, volume, etc. that exhibits the form, orientation, size, etc., of the target wellbore. For example, the wellbore representation may exhibit a planned and/or actual trajectory for the target wellbore. In some embodiments, the downhole scenario engine 126 implements the measurement data 132 with respect to the wellbore representation. For instance, the wellbore representation may include some or all of the measurement data 132 projected or displayed thereon. For example, the measurement data 132 may be borehole imaging data, and the downhole scenario engine 126 may incorporate the borehole imaging data on the wellbore representation in order to represent (e.g., in 2- or 3-dimensional space) the borehole imaging data. In some embodiments, the wellbore representation may incorporate an interpretation of the underlying measurement data 132. For example, the data manager 122 may analyze and/or interpret (e.g., or a user may interpret) the measurement data 132 and may identify one or several segments, zones, layers, strata, horizons, formations, or other partitions in the measurement data 132, and the wellbore representation may be generated to display or otherwise indicate these identifies partitions, for example, with different colors, textures, or any other demarcation. In this way, the wellbore representation may facilitate conceptualizing observed downhole measurements with respect to the wellbore (and the geobody as described herein).

As mentioned above, a downhole scenario presents a geobody with respect to a wellbore representation. The downhole scenario engine 126 may constrain the geobody to the wellbore representation. For example, the geobody may be constrained to a specific measurement depth where a corresponding subsurface feature was identified in the underlying measurement data. In some embodiments, the geobody may be constrained at a point where the geobody crosses or intersects the wellbore representation. The geobody may be constrained at any other point or measurement depth (e.g., in cases where the geobody/subsurface feature may not intersect the wellbore). For instance, the geobody may be modified in one or more respects (e.g., expanded, tilted, etc.) but may be fixed at one or more points or at a specific measurement depth. In this way, the geobody may be maintained at a point where the corresponding subsurface feature was identified in the measurement data while still allowing for flexibility to explore different forms, shapes, orientations, or other scenarios of the geobody/subsurface feature.

As mentioned above, in some cases the downhole scenario may include (e.g., only) the geobody and the wellbore representation, presented in 2- or 3-dimensional space. In some embodiments, the downhole scenario engine 126 may incorporate and/or model other subsurface representations or features, for example, based on additional measurement data. For instance, the downhole scenario engine 126 may incorporate formations, layers, strata, or horizons into the downhole scenario and with respect to the geobody and wellbore representation. In another example, the downhole scenario may include other subsurface object or features such as a downhole target or reservoir, or other wellbores.

In this way, the downhole scenario may be a geological model of various subsurface features, while incorporating the simplicity and adaptability of the geobody representation of a particular subsurface feature of interest. For instance, the downhole scenario engine 126 may facilitate modifying or manipulating the geobody in relation to the additionally represented information in order to explore and/or conceptualize different possible forms, orientations, etc., of the identified subsurface feature of interest. In another example, the downhole scenario engine 126 may facilitate generating multiple downhole scenarios associated with the same subsurface feature. For example, several different geobodies may be generated that vary in one or more respects, and the downhole scenario engine 126 may generate a corresponding downhole scenario for each different geobody, constrained to the same wellbore representation and/or incorporating the same additional information or additional subsurface features.

In some embodiments, the downhole scenario engine 126 may facilitate verifying or validating a geobody and/or downhole scenario. For example, as described herein, a geobody and downhole scenario (e.g., or several geobodies and downhole scenarios) may be generated that is a rough or generic approximation of a subsurface feature; that is based on limited measurement data or observation; that is not necessarily positioned, shaped, or oriented wholly accurately; and/or that is otherwise in need of validation. Such downhole scenarios may be useful for conceptualizing potential characteristics of a subsurface feature, and may be validated for ensuring that such conceptualizations are accurate the subsurface feature.

In some embodiments, the downhole scenario engine 126 may facilitate validating based on additional measurement data. For example, as more (e.g., of the same underlying measurement data) is received or available, a downhole scenario may be validated by verifying that the form, position, etc. of the geobody is consistent with the (e.g., new) measurements. In another example, additional measurement data channels or sources (e.g., of different types from the underlying measurement data) may be implemented to ensure consistency of the geobody. For instance, measurement data from a sidetrack or offset wellbore may indicate information indicating (e.g., one or more aspects of) the subsurface feature, and this information may be implemented to verify that the geobody is formed, shaped, positioned, oriented, etc., correctly.

In some embodiments, the downhole scenario engine 126 may facilitate performing one or more simulations in order to validate a downhole scenario. For example, the downhole scenario engine 126 may provide a downhole scenario as a basis for performing a simulation which the geobody representation of the subsurface feature, such as a simulation of a downhole operation, a simulation of a formation or reservoir (e.g., fluid flow), or another simulation. Based on the simulation, the downhole scenario engine 126 may validate the downhole scenario. For example, the simulation may be performed to generate or yield simulated measurement data, for example, of the same kind or type as the underlying measurement data (or any other measurement data available to the downhole scenario system 120). The downhole scenario engine 126 may validate the downhole scenario based on the simulated data being the same as, substantially similar to, or within a designated threshold of the actual measurement data, indicating that the geobody is formed, positioned, oriented, etc., in accordance with the actual form, position, orientation, etc., of the subsurface feature. In this way, the downhole scenario engine 126 may ensure that the geobody approximation of the subsurface feature, which may have been created as a quick, rough, and/or generic approximation, is accurate, true, or realistic to a threshold degree to the actual subsurface feature. In embodiments where multiple downhole scenarios are created for providing multiple potential representations of a subsurface feature, the downhole scenario engine 126 may facilitate validating each of the downhole scenarios (e.g., using any of the methods described) and selecting a downhole scenario that is most accurate or a best fit of the subsurface feature.

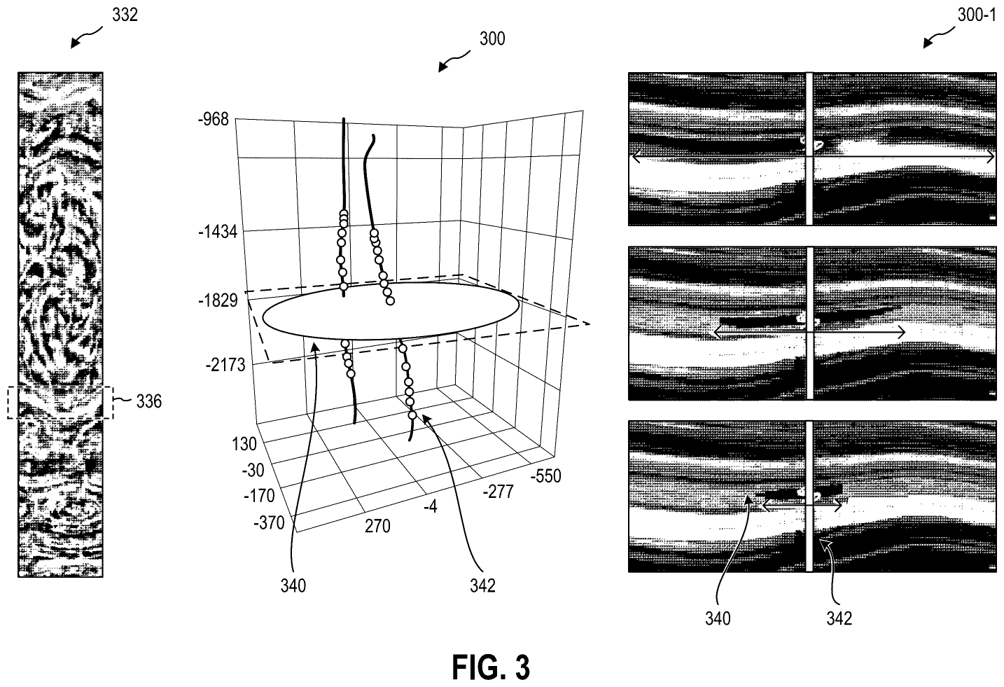

FIG. 3 is an example of a downhole scenario 300 generated by the downhole scenario system 120 as described herein, according to at least one embodiment of the present disclosure.

The downhole scenario system 120 may receive measurement data 332, such as borehole imaging data, for example, from acoustic or resistivity measurements. From the measurement data 332, the downhole scenario system 120 may identify an indication of a subsurface feature 336 of interest (e.g., automatically or based on user input). For instance, the subsurface feature 336 may be a slump. The downhole scenario system 120 may accordingly create a geobody 340 representing the subsurface feature 336 as described herein, and may generate the downhole scenario 300 presenting the geobody as constrained to a wellbore representation 342. As shown, the wellbore representation may indicate various measurements, data features, or otherwise from the measurement data 332 (or other available measurements), such as different layers or zones presented in relation to the wellbore representation 342. In some embodiments, the downhole scenario system 120 may generate one or more downhole scenarios 300-1 that may include additional information and/or may represent additional subsurface features. For example, 3 downhole scenarios 300-1a, 300-1b, and 300-1c incorporate layers, horizons, strata, formation boundaries, etc. in relation to the wellbore representation 342 and geobody 340. These multiple downhole scenarios 300-1 may include different geobodies that may represent the subsurface feature 336 in different ways in order to present and facilitate conceptualizing different possibilities for the subsurface feature.

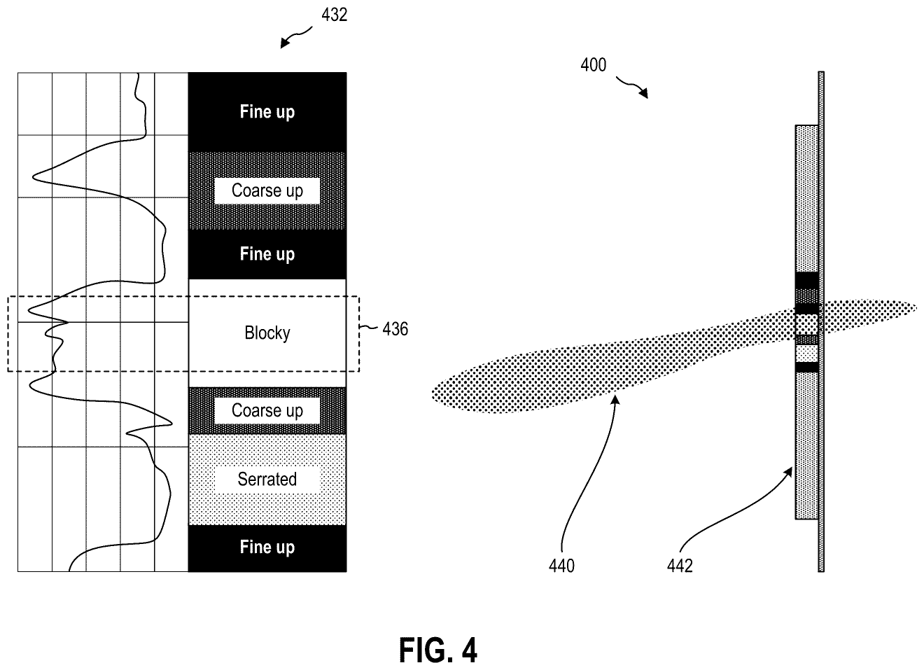

FIG. 4 is an example of a downhole scenario 400 generated by the downhole scenario system 120 as described herein, according to at least one embodiment of the present disclosure.

The downhole scenario system 120 may receive measurement data 432, such as gamma ray measurements. From the measurement data 432, the downhole scenario system 120 may identify an indication of a subsurface feature 436 of interest (e.g., automatically or based on user input). For instance, the subsurface feature 436 may be a lobe. The downhole scenario system 120 may accordingly create a geobody 440 representing the subsurface feature 436 as described herein, and may generate the downhole scenario 400 presenting the geobody as constrained to a wellbore representation 442. As shown, the wellbore representation may indicate various measurements, data features, or otherwise from the measurement data 432 (or other available measurements), such as different layers or zones presented in relation to the wellbore representation 442. For instance, the downhole scenario system 120 may segment and/or classify different portions of the measurement data 432, and the wellbore representation 442 may include or indicate these classifications. The downhole scenario 400 may be a 2-dimensional representation or may be 3-dimensional.

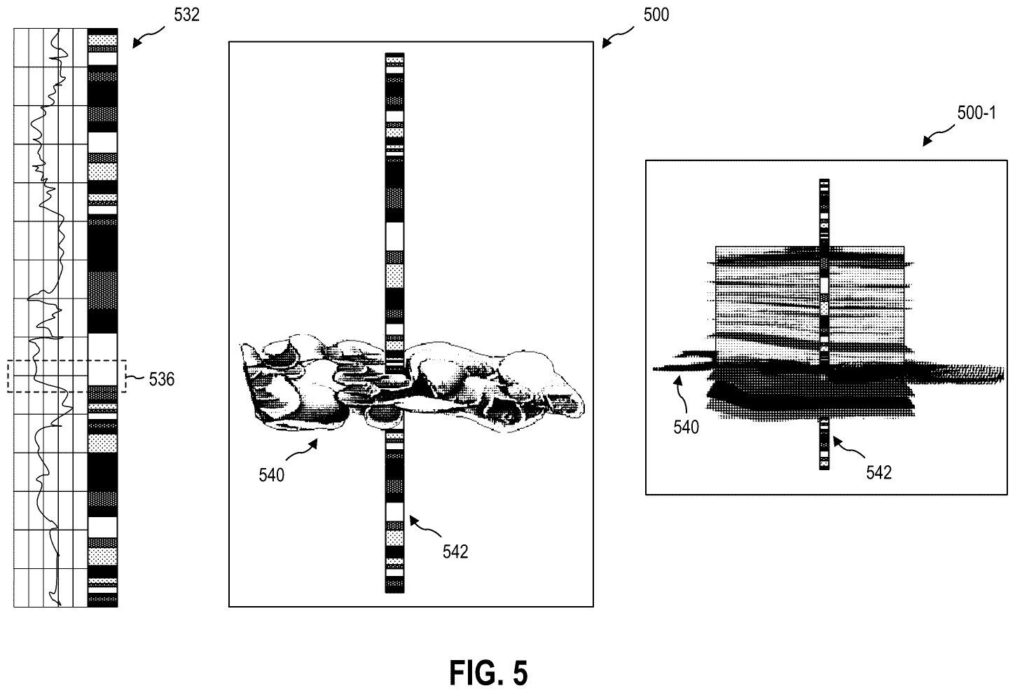

FIG. 5 is an example of a downhole scenario 500 generated by the downhole scenario system 120 as described herein, according to at least one embodiment of the present disclosure.

The downhole scenario system 120 may receive measurement data 532, such as porosity measurements. From the measurement data 532, the downhole scenario system 120 may identify an indication of a subsurface feature 536 of interest (e.g., automatically or based on user input). For instance, the subsurface feature 536 may be a channel. The downhole scenario system 120 may accordingly create a geobody 540 representing the subsurface feature 536 as described herein, and may generate the downhole scenario 500 presenting the geobody as constrained to a wellbore representation 542. As shown, the wellbore representation may indicate various measurements, data features, or otherwise from the measurement data 532 (or other available measurements), such as different layers or zones presented in relation to the wellbore representation 542. For instance, the downhole scenario system 120 may segment and/or classify different portions of the measurement data 532, and the wellbore representation 542 may include or indicate these classifications. In some embodiments, the downhole scenario system 120 may generate a downhole scenario 500-1 that may include additional information and/or may represent additional subsurface features. For example, downhole scenario 500-1 incorporates layers, horizons, strata, formation boundaries, etc. in relation to the wellbore representation 542 and geobody 540. This may facilitate conceptualizing the subsurface feature 536 in relation to one or more other subsurface features as well as in relation to the wellbore.

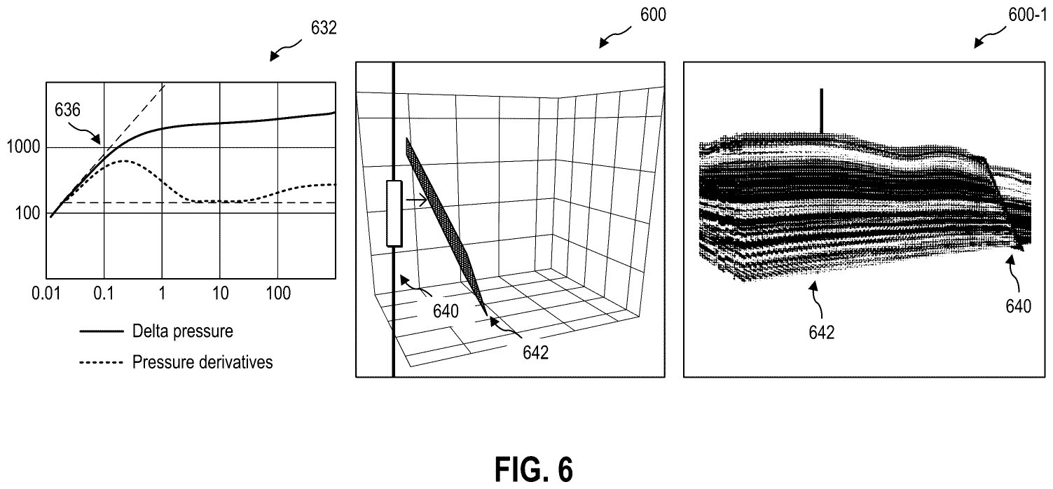

FIG. 6 is an example of a downhole scenario 600 generated by the downhole scenario system 120 as described herein, according to at least one embodiment of the present disclosure.

The downhole scenario system 120 may receive measurement data 632, such as pressure measurements. From the measurement data 632, the downhole scenario system 120 may identify an indication of a subsurface feature 636 of interest (e.g., automatically or based on user input). For instance, the subsurface feature may be a fault. The downhole scenario system 120 may accordingly create a geobody 640 representing the subsurface feature 636 as described herein, and may generate the downhole scenario 600 presenting the geobody as constrained to a wellbore representation 642, such as constrained to a specific measurement depth in relation to the wellbore representations 642. In some embodiments, the downhole scenario system 120 may generate a downhole scenario 600-1 that may include additional information and/or may represent additional subsurface features. For example, downhole scenario 600-1 incorporates layers, horizons, strata, formation boundaries, etc. in relation to the wellbore representation 642 and geobody 640. The additional subsurface features, (e.g., formation layers) may incorporate characteristics of the subsurface feature 536 (fault) such as by presenting one or more discontinuities at the subsurface feature 536.

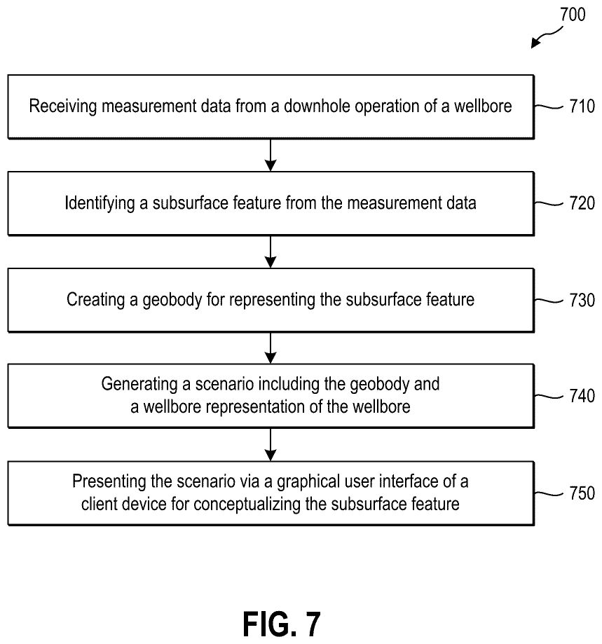

FIG. 7 illustrates a flow diagram for a method 700 or a series of acts for modeling a subsurface geology as described herein, according to at least one embodiment of the present disclosure. While FIG. 7 illustrates acts according to one embodiment, alternative embodiments may add to, omit, reorder, or modify any of the acts of FIG. 7. The acts of FIG. 7 may be performed as a method, may be performed by a system, or may be implemented as instructions stored in a computer-readable storage medium.

In some embodiments, the method 700 includes an at 710 of receiving measurement data from a downhole operation of a wellbore.

In some embodiments, the method 700 includes an act 720 of identifying a subsurface feature from the measurement data. For example, the measurement data may be measurement data of a first type, and the subsurface feature may be identified based on only the first type of measurement data. The subsurface feature may be a slump, lobe, fault, or channel.

In some embodiments, the method 700 includes an act 730 of creating a geobody for representing the subsurface feature. For example, the measurement data may be measurement data of a first type, and the subsurface feature may be identified and the geobody created based on only the first type of measurement data.

In some embodiments, creating the geobody includes selecting, from a predefined library of geobodies, a geobody having a same feature type as a feature type of the subsurface feature. In some embodiments, an analog geobody is selected, from a library of predefined geobodies, having one or more similar characteristics to the identified feature. For example, the analog geobody may be selected based on an underlying measurement data signal associated with the analog geobody being most similar to the measurement data than any other geobody of the library of predefined geobodies.

In some embodiments, the geobody is a prism, pipe, half pipe, ellipse, lobe, circle, oval, crescent, box, wedge, cone, or sheet. In some embodiments, the geobody may be modified by modifying one or more a dip, azimuth, size, shape, transversal extension, longitudinal extension, transversal position, or dimension of the geobody. For example, the geobody may be modified based on user input.

In some embodiments, the creating geobody includes identifying a plurality of candidate geobodies for representing the subsurface feature, and selecting the geobody from the candidate geobodies based on user input. In some embodiments, a custom geobody is created using a geobody machine learning model that is generated to process measurement data observed from a target wellbore and generate a geobody that reconciles one or more data features of the target wellbore data as a corresponding subsurface feature.

In some embodiments, the method 700 includes an act 740 of generating a scenario including the geobody and a wellbore representation of the wellbore. In some embodiments, the measurement data may be measurement data of a first type, and the subsurface feature may be identified and the geobody created based on only the first type of measurement data, and additionally, the wellbore representation may be represented with respect to the first measurement type.

In some embodiments, generating the downhole scenario includes identifying a measurement depth of the subsurface feature from the measurement data and constraining the geobody to the wellbore representation at the measurement depth. In some embodiments, the downhole scenario includes the geobody, the wellbore representation, and a representation of one or more additional subsurface features.

In some embodiments, the downhole scenario is a 2-dimensional visual representation of the geobody and the wellbore representation. In some embodiments, the downhole scenario is a 3-dimensional visual representation of the geobody and the wellbore representation.

In some embodiments, the method 700 includes validating the generated downhole scenario based on additional measurement data. For example, the additional measurement data may be measurement data from an offset wellbore or a sidetrack wellbore. The additional measurement data may be measurement data that is received after generating the downhole scenario. Validating the generated downhole scenario may be based on simulating one or more wellbore operations based on the geobody and the wellbore representation to generate simulated measurement data and verifying that the simulated measurement data is substantially accurate to the measurement data.

In some embodiments, the geobody is a first geobody and the downhole scenario is a first downhole scenario, and the method further includes creating a second geobody different from the first geobody in one or more properties, generating a second downhole scenario including the second geobody constrained to the representation of the wellbore, performing a first simulation of an operation of the wellbore based on the first downhole scenario to generate first simulated measurement data, performing a second simulation of the operation of the wellbore based on the second downhole scenario to generate second simulated measurement data, and selecting the first downhole scenario including the first geobody for representing the subsurface feature based on the first simulated measurement data being more accurate to the measurement data than the second measurement data. In some embodiments, the first downhole scenario may be provided for operating the wellbore. In some embodiments, the second downhole scenario and the second measurement data are not accurate to the measurement data. For example, the first simulated measurement data may be more accurate based on the first simulated measurement data correctly recreating one or more data feature indicated in the measurement data. In some embodiments, the second geobody is different from the first geobody based on having one or more differences in dip, azimuth, size, shape, transversal extension, longitudinal extension, transversal position, or dimension of the second geobody.

In some embodiments, the method 700 includes an act 750 of presenting the scenario via a graphical user interface of a client device for conceptualizing the subsurface feature.

In some embodiments, the method 700 includes providing the downhole scenario for operating the wellbore. For example, the downhole scenario may be provided to facilitate one or more of a steering operation, completion operation, production operation, or stimulation operation. In some embodiments, the downhole scenario may be provided to facilitate simulating a downhole operation for the wellbore.

Turning now to FIG. 8, this figure illustrates certain components that may be included within a computer system 800. One or more computer systems 800 may be used to implement the various devices, components, and systems described herein.

The computer system 800 includes a processor 801. The processor 801 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used.

The computer system 800 also includes memory 803 in electronic communication with the processor 801. The memory 803 may include computer-readable storage media and can be any available media that can be accessed by a general purpose or special purpose computer system. Computer-readable media that store computer-executable instructions are non-transitory computer-readable media (device). Computer-readable media that carry computer-executable instructions are transmission media. Thus, by way of example and not limitations, embodiment of the present disclosure can comprise at least two distinctly different kinds of computer-readable media: non-transitory computer-readable media (devices) and transmission media.

Both non-transitory computer-readable media (devices) and transmission media may be used temporarily to store or carry software instructions in the form of computer readable program code that allows performance of embodiments of the present disclosure. Non-transitory computer-readable media may further be used to persistently or permanently store such software instructions. Examples of non-transitory computer-readable storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored or in software, hardware, firmware, or combinations thereof.

Instructions 805 and data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during execution of the instructions 805 by the processor 801.

A computer system 800 may also include one or more communication interfaces 809 for communicating with other electronic devices. The communication interface(s) 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

The communication interfaces 809 may connect the computer system 800 to a network. A “network” or “communications network” may generally be defined as one or more data links that enable the transport of electronic data between computer systems and/or modules, engines, or other electronic devices, or combinations thereof. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instruction or data structures and which can be accessed by a general purpose or special purpose computer.

A computer system 800 may also include one or more input devices 811 and one or more output devices 813. Some examples of input devices 811 include a keyboard, mouse, microphone, remote control device, button, joystick, trackball, touchpad, and lightpen. Some examples of output devices 813 include a speaker and a printer. One specific type of output device that is typically included in a computer system 800 is a display device 815. Display devices 815 used with embodiments disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into one or more of text, graphics, or moving images (as appropriate) shown on the display device 815.

The various components of the computer system 800 may be coupled together by one or more buses, which may include one or more of a power bus, a control signal bus, a status signal bus, a data bus, other similar components, or combinations thereof. For the sake of clarity, the various buses are illustrated in FIG. 8 as a bus system 819.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Further, upon reaching various computer system components, program code in the form of computer-executable instructions or data structures can be transferred automatically or manually from transmission media to non-transitory computer-readable storage media (or vice versa). For example, computer executable instructions or data structures received over a network or data link can be buffered in memory (e.g., RAM) within a network interface module (NIC), and then eventually transferred to computer system RAM and/or to less volatile non-transitory computer-readable storage media at a computer system. Thus, it should be understood that non-transitory computer-readable storage media can be included in computer system components that also (or even primarily) utilize transmission media.

### INDUSTRIAL APPLICABILITY

The following description includes various embodiments that, where feasible, may be combined in any permutation. For example, the embodiment of the immediately following paragraph may be combined with any or all embodiments of the following paragraphs. Embodiments that describe acts of a method may be combined with embodiments that describe, for example, systems and/or devices. Any permutation of the following paragraphs is considered to be hereby disclosed for the purposes of providing “unambiguously derivable support” for any claim amendment based on the following paragraphs. Furthermore, the following paragraphs provide support such that any combination of the following paragraphs would not create an “intermediate generalization.”

In some embodiments, a method of modeling a subsurface geology includes receiving measurement data from a downhole operation of a wellbore, identifying a subsurface feature from the measurement data, creating a geobody for representing the subsurface feature, generating a downhole scenario including the geobody and a wellbore representation of the wellbore, and presenting the downhole scenario via a graphical user interface of a client device for conceptualizing the subsurface feature.

In some embodiments, generating the downhole scenario includes identifying a measurement depth of the subsurface feature from the measurement data and constraining the geobody to the wellbore representation at the measurement depth.

In some embodiments, the measurement data is measurement data of a first type, and the subsurface feature is identified based on only the first type of measurement data.

In some embodiments, creating the geobody is based on only the first type of measurement data.

In some embodiments, the wellbore representation is represented with respect to the measurement data of the first type.

In some embodiments, generating the downhole scenario includes generating a geological model including the geobody, the wellbore representation, and a representation of one or more additional subsurface features.

In some embodiments, creating the geobody includes selecting, from a predefined library of geobodies, a geobody having a same feature type as a feature type of the subsurface feature.

In some embodiments, creating the geobody includes selecting, from a library of predefined geobodies, an analog geobody having one or more similar characteristics to the identified subsurface feature.

In some embodiments, selecting the analog geobody includes identifying that an underlying measurement data signal associated with the analog geobody is most similar to the measurement data than any other geobody of the library of predefined geobodies.

In some embodiments, creating the geobody includes identifying a plurality of candidate geobodies for representing the subsurface feature, and selecting the geobody from the candidate geobodies based on user input.

In some embodiments, creating the geobody includes creating a custom geobody using a geobody machine learning model that is generated to process target measurement data observed from a target wellbore and generate a geobody that reconciles one or more data features of the target wellbore data as a corresponding subsurface feature.

In some embodiments, the method further includes modifying the geobody including one or more of modifying a dip, azimuth, size, shape, transversal extension, longitudinal extension, transversal position, or dimension of the geobody.

In some embodiments, the geobody is modified based on receiving user input.

In some embodiments, the subsurface feature is a slump, a lobe, a fault, or a channel.

In some embodiments, the downhole scenario is a 2-dimensional visual representation of the geobody and the wellbore representation.

In some embodiments, the downhole scenario is a 3-dimensional visual representation of the geobody and the wellbore representation.

In some embodiments, the geobody is a prism, pipe, half pipe, ellipse, lobe, circle, oval, crescent, box, wedge, cone, or sheet.

In some embodiments, the method includes validating the downhole scenario based on additional measurement data.

In some embodiments, the additional measurement data is measurement data from an offset wellbore or a sidetrack wellbore.

In some embodiments, the addition measurement data is received after generating the downhole scenario.

In some embodiments, validating the downhole scenario is based on simulating one or more wellbore operations based on the geobody and the wellbore representation to generate simulated measurement data and further including verifying that the simulated measurement data is substantially accurate to the measurement data.

In some embodiments, the method further includes providing the downhole scenario for operating the wellbore.

In some embodiments, operating the wellbore includes performing one or more downhole operations including a steering operation, completion operation, production operation, or stimulation operation.

In some embodiments, operating the wellbore includes simulating a downhole operation for the wellbore.

In some embodiments, the geobody is a first geobody and the downhole scenario is a first downhole scenario, and the method further includes creating a second geobody different from the first geobody in one or more properties, generating a second downhole scenario including the second geobody constrained to the wellbore representation, performing a first simulation of an operation of the wellbore based on the first downhole scenario to generate first simulated measurement data, performing a second simulation of the operation of the wellbore based on the second downhole scenario to generate second simulated measurement data, and selecting the first downhole scenario including the first geobody for representing the subsurface feature based on the first simulated measurement data being more accurate to the measurement data than the second simulated measurement data.

In some embodiments, the method includes providing the first downhole scenario for operating the wellbore.

In some embodiments, the second downhole scenario and the second simulated measurement data are not accurate to the measurement data.

In some embodiments, the first simulated measurement data is more accurate based on the first simulated measurement data correctly recreating one or more data features indicated in the measurement data.

In some embodiments, the second geobody is different from the first geobody based on having one or more differences in dip, azimuth, size, shape, transversal extension, longitudinal extension, transversal position, or dimension of the second geobody.

In some embodiments, a system includes at least one processor, memory in electronic communication with the at least one processor, and instructions stored in the memory, the instructions being executable by the at least one processor to receive measurement data from a downhole operation of a wellbore, identify a subsurface feature from the measurement data, create a geobody for representing the subsurface feature, generate a downhole scenario including the geobody and a wellbore representation of the wellbore, and present the downhole scenario via a graphical user interface of a client device for conceptualizing the subsurface feature.

In some embodiments, a computer-readable storage medium includes instruction that, when executed by at least one processor, cause the processor to receive measurement data from a downhole operation of a wellbore, identify a subsurface feature from the measurement data, create a geobody for representing the subsurface feature, generate a downhole scenario including the geobody and a wellbore representation of the wellbore, and present the downhole scenario via a graphical user interface of a client device for conceptualizing the subsurface feature.

The embodiments of the downhole scenario system have been primarily described with reference to wellbore drilling operations; the downhole scenario system described herein may be used in applications other than the drilling of a wellbore. In other embodiments, the downhole scenario system according to the present disclosure may be used outside a wellbore or other downhole environment used for the exploration or production of natural resources. For instance, the downhole scenario system of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements. Additionally, as used herein, the term “and/or” includes any and all combinations of one or more of the associated listed items.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of modeling a subsurface geology, comprising:
receiving measurement data from a downhole operation of a wellbore;
identifying a subsurface feature from the measurement data;
creating a geobody for representing the subsurface feature;
generating a downhole scenario including the geobody and a wellbore representation of the wellbore; and
presenting the downhole scenario via a graphical user interface of a client device for conceptualizing the subsurface feature.

2. The method of claim 1, wherein generating the downhole scenario includes identifying a measurement depth of the subsurface feature from the measurement data and constraining the geobody to the wellbore representation at the measurement depth.

3. The method of claim 1, wherein the measurement data is measurement data of a first type, and the subsurface feature is identified based on only the first type of measurement data.

4. The method of claim 3, wherein creating the geobody is based on only the first type of measurement data.

5. The method of claim 3, wherein the wellbore representation is represented with respect to the measurement data of the first type.

6. The method of claim 1, wherein generating the downhole scenario includes generating a geological model including the geobody, the wellbore representation, and a representation of one or more additional subsurface features.

7. The method of claim 1, wherein creating the geobody includes selecting, from a library of predefined geobodies, an analog geobody having one or more similar characteristics to the identified subsurface feature.

8. The method of claim 7, wherein selecting the analog geobody includes identifying that an underlying measurement data signal associated with the analog geobody is most similar to the measurement data than any other geobody of the library of predefined geobodies.

9. The method of claim 1, further comprising modifying the geobody including one or more of modifying a dip, azimuth, size, shape, transversal extension, longitudinal extension, transversal position, or dimension of the geobody.

10. The method of claim 1, further comprising validating the downhole scenario based on additional measurement data.

11. The method of claim 10, wherein the addition measurement data is received after generating the downhole scenario.

12. The method of claim 10, wherein validating the downhole scenario is based on simulating one or more wellbore operations based on the geobody and the wellbore representation to generate simulated measurement data and further including verifying that the simulated measurement data is substantially accurate to the measurement data.

13. The method of claim 10, further comprising providing the downhole scenario for operating the wellbore.

14. The method of claim 13, wherein operating the wellbore includes performing one or more downhole operations including a steering operation, completion operation, production operation, or stimulation operation.

15. The method of claim 13, wherein operating the wellbore includes simulating a downhole operation for the wellbore.

16. The method of claim 1, wherein the geobody is a first geobody and the downhole scenario is a first downhole scenario, the method further including:
creating a second geobody different from the first geobody in one or more properties;
generating a second downhole scenario including the second geobody constrained to the wellbore representation;
performing a first simulation of an operation of the wellbore based on the first downhole scenario to generate first simulated measurement data;
performing a second simulation of the operation of the wellbore based on the second downhole scenario to generate second simulated measurement data; and
selecting the first downhole scenario including the first geobody for representing the subsurface feature based on the first simulated measurement data being more accurate to the measurement data than the second simulated measurement data.

17. The method of claim 16, wherein the second downhole scenario and the second simulated measurement data are not accurate to the measurement data.

18. The method of claim 16, wherein the first simulated measurement data is more accurate based on the first simulated measurement data correctly recreating one or more data features indicated in the measurement data.

19. The method of claim 16, wherein the second geobody is different from the first geobody based on having one or more differences in dip, azimuth, size, shape, transversal extension, longitudinal extension, transversal position, or dimension of the second geobody.

20. A system, comprising:
at least one processor;
memory in electronic communication with the at least one processor; and
instructions stored in the memory, the instructions being executable by the at least one processor to:
receive measurement data from a downhole operation of a wellbore;
identify a subsurface feature from the measurement data;
create a geobody for representing the subsurface feature;
generate a downhole scenario including the geobody and a wellbore representation of the wellbore; and
present the downhole scenario via a graphical user interface of a client device for conceptualizing the subsurface feature.
